(19) United States
(12) Patent Application Publication
(10) Pub. No.: US 2010/0143622 A1
(43) Pub. Date: Jun. 10, 2010

(54) PROCESS FOR PROVIDING ALUMINIUM COOKWARE WITH A COPPER COATING

(75) Inventor: Hendrik Adolf Schreuder, Vianen (NL)

Correspondence Address: KNOBBE MARTENS OLSON & BEAR LLP, 2040 MAIN STREET, FOURTEENTH FLOOR, IRVINE, CA, 92614, US

(73) Assignee: ANOX B.V., Scherpenzeel (NL)

(21) Appl. No.: 12/516,185

(22) PCT Filed: Nov. 23, 2006
(86) PCT No.: PCT/EP2006/012049

§ 371 Date: Jan. 20, 2010

(51) Int. Cl. B32B 15/04; A47J 36/02; B32B 15/20; A47J 27/00; C25D 11/22

(52) U.S. Cl. 428/34.7; 428/472.2; 205/173

(57) ABSTRACT

The present invention relates to a process for providing an aluminium article with a copper coating, comprising a first step of anodizing said aluminium article to produce an anodic oxide layer on the surface thereof; and a second step of colouring the anodized aluminium surface in an electrolytic bath containing a copper salt by subjecting the aluminium surface to an asymmetrical voltage controlled alternating block current having a positive phase and a negative phase, such that a metallic copper coloured coating is formed. The invention also relates to aluminium articles, provided with a copper coating, obtainable by said process.

The present application relates to a process for providing aluminium articles, in particular for providing aluminium cookware, such as pots and pans, with a copper coloured coating. The invention also relates to the aluminium articles, obtainable by said process.

Copper cookware is the choice of many professional cooks because it is the best conductor of heat. Thus a pot or pan made from copper will respond very quickly to temperature changes and due to this superior heat conduction food is cooked very evenly. A drawback of copper is that copper is a reactive metal. This means the copper will chemically combine with certain foods, usually highly acidic foods, and thus may alter the appearance and flavour of the dish, which is generally not desirable. Some copper cookware is lined with tin or stainless steel to remedy this problem. In addition, copper cookware require frequent cleaning and/or polishing to maintain its shine and to remove fingerprints. Finally, copper cookware is quite costly.

It is also known the use aluminium cookware. Thus, aluminium, also being a good conductor of heat, is generally less expensive. Like copper, aluminum is a reactive metal, which means it can alter the appearance and flavour of certain foods, such as eggs. Aluminium cookware therefore generally is anodized with a dark gray finish, a process that makes the aluminium non-reactive. Although by using aluminium cookware instead of copper cookware, some of the drawbacks of copper cookware may be solved, many people still prefer to use copper cookware due to its more attractive appearance.

The object of the present invention is to provide “copper” articles, in particular cookware such as pots and pans, which do not have the drawbacks of conventional copper articles.

This object is achieved by the invention by a process for providing an aluminium article with a copper coating, comprising a first step wherein said aluminium article is anodized to produce an anodic oxide layer on the surface thereof, and a second step wherein the anodized aluminium surface is coloured in an electrolytic bath at least comprising a copper salt, by subjecting the aluminium surface to an asymmetrical voltage controlled block pulse having a positive phase and a negative phase, such that a metallic copper coloured coating is formed on the aluminium surface.

According to the present invention it has been found that by subjecting the aluminium article in an electrolytic bath of an aqueous solution containing e.g. sulphuric acid and a copper salt, with the aluminium article being used as at least one of the electrodes, to voltage controlled asymmetrical block current, said article can be provided with a metallic copper coating, thus having a “copper look”. That is, the aluminium article typically looks like a copper article.

In a preferred embodiment of the invention, the process is used for providing aluminium cookware with a copper coating, i.e. aluminium cookware with a “copper look”. Thus, the process according to the invention is in particular suitable for the production of aluminium kitchen utilities, such as electrical fondue sets and kettles, pans, pots, non-electrical cooking utensils, fish pans, woks, non-electrical fondue sets and kettles, and cooking pots. According to the invention it has been found that the copper coating is durable and even withstands the high temperatures which may be encountered during e.g. cooking. Advantageously, the article does not have the common drawbacks that are associated with the use of copper articles. Thus, the article is for example less expensive and does not require frequent cleaning and/or polishing.

It is known that anodized aluminium may be coloured, by means of electrolytic processes. Thus, it is known that the anodic oxide film on the surface of the aluminium generally may be coloured by the passage of alternating current, or alternating current with superimposed direct current, between the anodized aluminium and a counter electrode immersed in an electrolyte containing certain metallic compounds. The electrolyte may contain cations of nickel, cobalt, copper, tin, chromium, silver, iron or lead and anions of nitrate, sulphate, phosphate, acetate, oxalate, citrate or a selenite, tellurite, manganate or permanganate and is maintained at an acid pH, dependent on the compound present in the bath. In some instances the bath may contain salts of two or more metals. The operability of this process has been explained on the assumption that because of the blocking effect of the anodic oxide film, the total charge during the intervals when the aluminium is cathodic is greater than when the aluminium is anodic so that the metal deposit from the electrolyte deposit from the electrolyte during the cathodic intervals is greater than the amount re-dissolved during the anodic intervals. Under these circumstances the anodic oxide coating on the aluminium becomes coloured and depending on the selected metal and intensity or duration of the treatment a variety of colours are obtainable. When copper is being used, these processes generally result in faint red, brick or brownish colours.

In contrast, according to the present invention it has been found that by subjecting the anodized aluminium article to an asymmetrical block current, a metallic copper coloured coating is provided on the surface of the aluminium, such that the article, although essentially consisting of aluminium, looks like a copper article.

In the first step of the process according to the invention, the surface of the aluminium article is anodized in a conventional manner to produce an anodic oxide coating, e.g. of a type customarily applied for protective or like purposes, which are known to the skilled person. While any of a number of known operations may be employed, notably with electrolytes of a group which may be defined as consisting of aqueous solutions of sulphuric acid, chromic acid, or a sulfonic acid such as sulfosalicyclic acid, and suitable mixtures of these with other acids or compounds, and while in some cases alternating current anodizing treatment may be feasible, effective results are obtained by anodizing the articles, such as pots and pans, with direct current, for periods of 20 minutes to 60 minutes in an aqueous solution of sulphuric acid, e.g. in a concentration of 15% acid by weight. The operating conditions of the anodizing step generally are not very critical, being selected largely to suit the thickness, hardness and other characteristics of anodic coating desired. The requirements of the subsequent colouring step are satisfied over a considerable range of thickness of porous oxide coating on aluminium.

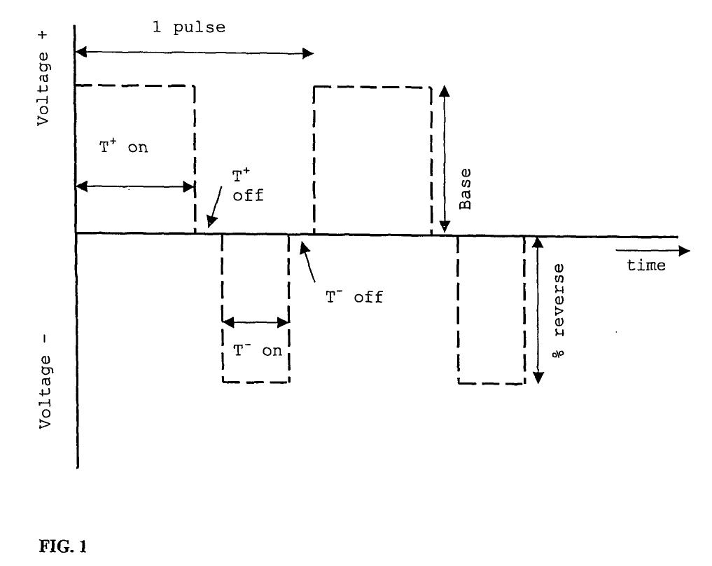

In the colouring step, the aluminium article is subjected to an asymmetrical voltage controlled block pulse, as defined in FIG. 1. In contrast, conventional colouring processes generally use a 50 Hz alternating frequency with or without a superimposed DC current. When an asymmetrical voltage controlled block pulse having a positive phase and a negative phase is used, the copper deposition can be controlled and more vivid and uniform colours can be produced. To overcome the blocking effect and to deposit metals at the bottom of the pores of the anodic layer, it is essential to use a negative phase in the pulse. To avoid uncontrolled copper depositions, it is essential to have a positive phase. In the positive phase the excess of metal is dissolved when a minimum of current is present and the barrier layer is modified to facilitate the deposition of metals in the pores of the anodic layer in the next negative phase. The counter electrode in the colouring step preferably is made of a material which is inert to the electrolyte, such as carbon (graphite) or stainless steel.

According to a preferred embodiment of the invention, the mean current density applied to the aluminium surface in the positive phase is between 0.00 and 0.05 A/dm². When in the positive phase the amount of current is between 0.00 A/dm² and 0.05 A/dm², a uniform and vivid copper colour of the anodized aluminium material is obtained. When the current in the positive phase is greater than 0.05 A/dm², a greyish colour will be obtained due to the over-modification of the barrier layer.

The current density is dependent on e.g. the voltage applied. The voltage applied thus preferably is sufficient to permit a mean current density in the positive phase of between 0.00 and 0.05 A/dm².

Preferably, the mean current density in the negative phase is between 0.08 and 0.4 A/dm². When in the negative phase the amount of current is between 0,08 A/dm² and 0.4 A/dm2, the amount of deposited metals results in vivid metallic colours. With a current density below 0.08 A/dm², too little metal is deposited to obtain vivid colours, and when the current density is above 0.4 A/dm² the amount of metals deposited is uncontrolled.

Both the frequency and the relation between the positive phase and negative phase of the pulse may affect the ratio of anodic/cathodic current and e.g. the rate of colouring. For example, a lower frequency increases the ratio of anodic current/cathodic current. According to the invention the relation between positive and negative phase is calculated as % FF, which relates to the proportion of the positive phase in the total pulse (see below). A higher % FF results in an increased rate of colouring. However, with increasing colouring rate the risk of deviations in the colour may also increase.

In a preferred embodiment of the present invention, the frequency of the used pulse is between 5 and 50 Hz, preferably between 10 and 40 Hz, more preferably, between 15 and 30 Hz, most preferably the frequency is approximately 20 Hz.

In a further preferred embodiment, the relation between the positive phase and negative phase, i.e. the % FF, is above 50%, preferably above 60%, more preferably between 80% and 100%, most preferably approximately 80%.

Although the exact process time may vary, depending on e.g. the desired colour intensity, preferably the duration of the colouring step may vary between 5 and 15 minutes.

The electrolytic bath in the colouring step preferably comprises an acidic aqueous solution containing at least a copper salt. Suitable copper salts are for example copper sulfates, copper acetates or copper phosphates.

In a further preferred embodiment, the electrolysis bath comprises a copper salt, e.g. copper sulphate, in a concentration of 1-100 g/l, preferably, 5-75 g/l, more preferably 10-50 g/l, more preferably 15-25 g/l, in particular 20 g/l.

In a preferred embodiment, the electrolysis bath comprises sulphuric acid in a concentration of 0,5-25 g/l, preferably, 1-20 g/l, more preferably 2-10 g/l, most preferably 3-7 g/l, in particular 5 g/l.

The electrolysis bath preferably is balanced with de-ionized water with a temperature of 15-25° C.

In a preferred embodiment, aluminium and/or magnesium salts may be added to the electrolyte as an inhibitor of spalling and to improve the uniformity of colour. Preferably, the electrolysis bath further comprises magnesium sulphate or aluminium sulphate in a concentration of 0-50 g/l, preferably 20 g/l.

The final appearance of the article, such as the pots and pans, can be influenced by different types of mechanical and/or chemical (pre-)treatments. Also combinations of treatments can be used to influence the appearances of the pots and pans after the process. Mechanical treatment methods include for example but not exclusively sandblasting, beat blasting, polishing, sanding etc. Chemical treatment methods include for example but not exclusively degreasing, caustic etching, acid etching, chemical polishing, and electro-chemical polishing. These treatments are known to the skilled person. The process of the present invention thus may be combined with one or more of these known (pre-)treatments.

The aluminium article with the copper coating, obtained with the process according to the invention may further be subjected to a final sealing step. The sealing step for example comprises hot water sealing, cold sealing or impregnation sealing.

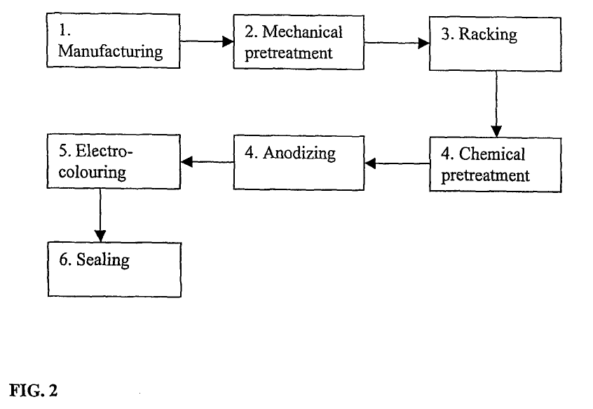

As shown in FIG. 2, in a suitable embodiment, the process of the present invention may be combined with a combination of conventional pretreatment steps and a final sealing step.

The present invention further relates to an aluminium article, provided with a copper coating, obtainable by the process as described above.

The invention in particular relates to aluminium cookware having a copper look, obtainable by said process. It should be understood, however, that the process of the present invention can also be used for other applications, wherein a copper-like article may be desirable, without having the drawbacks associated with copper articles.

The following definitions have been used according to the invention:

Alternating current generally relates to an electrical current whose magnitude and direction vary cyclically, as opposed to direct current whose direction remains constant. The usual waveform of an AC power circuit is a sine wave, wherein the positive phase and negative phase are symmetrical.

According to the present invention, use is made of an asymmetrical block pulse, i.e. having a rectangular waveform and wherein the positive phase and a negative phase are asymmetrical. An asymmetrical block pulse according to the invention is shown in FIG. 1.

The wording “voltage controlled” means that the pulse is controlled by applying a predetermined voltage pulse.

According to the invention, an article having a copper coating relates to an article having the appearance of a copper article, i.e. with a “look” of metallic copper. The aluminium material itself may be industrially pure aluminium metal or may be an aluminium alloy in which aluminium is the major alloy constituent.

The present invention is further illustrated by the following examples and figures.

FIG. 1 shows the waveform of the asymmetrical alternating block current according to the invention. Said asymmetrical voltage controlled block current is defined by the following parameters:

T⁺on=on time positive phase [ms]

T⁺off=off time positive phase [ms]

T⁺=T⁺on+T⁺off [ms]

T⁻on=on time negative phase [ms]

T⁻off=off time negative phase [ms]

T⁻=T⁻on+T⁻off [ms]

Base voltage=operating voltage [V]

% negative phase=(negative voltage/base voltage)*100% [−]

T⁺ repetition=the number of times T⁺ reoccurs before T⁻ begins [−]

T⁻ repetition=the number of times T⁻ reoccurs before T⁺ begins [−]

pulse time=(T⁺ repetition*+T⁺) +(T⁻ repetition*[ms]

% FF=(T⁺on*T⁺ repetition)/pulse time)*100% [−]

FIG. 2 schematically shows the subsequent steps of a preferred embodiment of the process according to the present invention. First, the aluminium article is manufactured using conventional methods 1. The production of the aluminium cookware, such as aluminium pots and pans can be done by conventional production methods. If required a (non-stick) coating can be applied on the inside and/or outside surface of the aluminium pots and pans. Depending on the quality of the coating, the coating will not be harmed by the described process. The aluminium article may be made of industrially pure aluminium metal or may be an aluminium alloy in which aluminium is the major alloy constituent.

At 2 the article is subjected to a mechanical pretreatment step, such as e.g. sandblasting, polishing etc. Any conventional pretreatment, known to the skilled person may be used.

For the process of the invention, the aluminium article must be placed and immersed in the electrolysis bath. To this end, the aluminium article generally is placed on suitable racks in the electrolysis bath (“racking” 3). Due to the use of alternating current in the colouring process, titanium is not a useful material for the racking process, unless all bear titanium has been masked from the electrolyte. Racks made from aluminium are preferable. A minimum contact area of 1 mm² per m² of the aluminium article is required in order to get an uniform anodic coating and colour. Due to the galvanic effects between the racks and the material, its is important to keep the time period between racking and anodizing as short as possible. Preferably, this time period is limited to 24 hours.

After racking, the article preferably is subjected to a chemical pretreatment step 4, such as degreasing, caustic etching etc.

According to the process of the invention, the aluminium article is then first anodized to produce an anodic oxide layer on the surface of the aluminium article (reference number 5). In the second step of the process of the invention (reference number 6), the anodized aluminium article is provided with a copper coloured coating. Finally, the article is subjected to a final sealing step 7, such that an aluminium article having a copper look is obtained.

### Examples

### Anodizing Process

In the following specific examples of the process according to the invention, aluminium pots and pans were first anodized by conventional sulphuric anodic treatment with direct current between 0,5 to 2 ampere/dm²′ during 20 and 90 minutes in a 15% to 25% sulphuric acid solution, containing a maximum of 20 g/l aluminium at a temperature between 16 to 22° C. To enhance abrasion resistance oxalate acid can be added in a concentration of between 0 and 30 g/l.

### Electrolyte for Colouring Step

An electrolyte containing copper sulphate with a concentration of 10-50 g/l, preferably 20 g/l, magnesium sulphate with a concentration of 10-50 g/l, preferably 20 g/l, sulphuric acid with a concentration of 2-10 g/l, preferably 5 g/l, balanced with de-ionised water with a temperature of 15-25° C. was used as the colouring bath.

### Process Parameters

The following process parameters were fixed during the colouring treatment, using the above-described anodizing process and electrolyte:

Ramp=0.5 V/s

T+off=0 ms

T−off=0 ms

T+ repetition=1

T− repetition=1

% reverse=100%

### Example 1

### Reference Colours

Six aluminium plates with a surface of 1.3 dm² were first anodized according to the above-mentioned procedure and afterwards coloured in the above-mentioned electrolyte. The below mentioned pulse was used to determine the degree of colouring, wherein only the total process time was varied between 200 and 1600 seconds, with an interval of 200 seconds.

Base voltage=16 V

T+on=40 ms

T−on=10 ms

pulse time=50 ms

% FF=80%

Process time
[s]

| | 200 | 400 | 600 | 800 | 1000 | 1200 |
|---|---|---|---|---|---|---|
| Colour | Cf1 | Cf2 | Cf3 | Cf4 | Cf5 | Cf6 |
| scale | | | | | | |
| [—] | | | | | | |

The test results show clearly the influence of the process time on the colouring process. A longer process time results in darker colours. The resulting colours vary from light copper look (Cf1) to black (Cf6). In contrast, with the traditional pulse of 50 Hz AC, the colours obtained tend to be more brownish instead of reddish.

### Example 2

### Influence of Base Voltage

The influence of the base voltage on the colour obtained was determined using aluminium pans with a surface of 10 dm². The following process parameters were used:

T+on=40 ms

T−on=10 ms

pulse time=50 ms

% FF=80%

Process time=300 s

| | Base voltage | | | | |
|---|---|---|---|---|---|
| | [V] | | | | |
| | 10 | 13 | 15 | 16 | 19 |
| Colour scale | Greyish | Pink | Cf1 | Cf2 | Cf4 |
| [—] | | | | | |

It was found that the base voltage determines the colouring speed of the process. Thus, a lower base voltage results in slower colouring speeds.

It is known from other tests that the electrical resistance of the anodic coating has effect on the current which will flow during the process and thereby the speed of colouring process. For the specific type of the anodic coating used during testing a minimum voltage of 13 V is necessary to obtain good colouring results. If the electrical resistance of the anodic coating is lower, good colouring results can be obtained with a lower, e.g. 10 V, base voltage. If the base voltage is raised, e.g. 20 V, the speed of the colouring process increases to such a degree that the colouring process is no longer controllable and the risk of spalling increases.

### Example 3

### Influence of Frequency

The influence of the frequency of the asymmetrical voltage controlled block pulse was determined using aluminium pans with a surface of 10 dm². The following process parameters were used:

Base voltage=16 V

% FF=80%

Process time=300 s

| Frequency [Hz] | 5 | 20 | 50 | 100 |
|---|---|---|---|---|
| T+ on | 160 | 40 | 16 | 8 |
| T− on | 40 | 10 | 4 | 2 |
| Colour scale [−] | Cf1 | Cf3 | Cf3 | Cf2 |

It was found that the frequency of the asymmetrical voltage controlled block pulse influences the speed of the colouring process. A minimum frequency of 1 Hz is needed in order to keep the colouring process running. The energy consumption of the process, i.e. Coulombs used, increases with increasing frequencies. With regard to energy consumption, the process is limited to a frequency of 100 Hz.

### Example 4

### Influence of % FF

The influence of the % FF was determined using aluminium pans with a surface of 10 dm². The following process parameters were used

Pulse time=50 ms

Base voltage=16 V

Proces time=300 s

| % FF | 20 | 50 | 80 | 90 |
|---|---|---|---|---|
| T+ on | 10 | 25 | 40 | 45 |
| T− on | 40 | 25 | 10 | 5 |
| Colour scale [−] | Black | Brown | Cf2 | Cf1 |

The % FF has influence on the speed of the colouring process and the colours obtained. With % FF greater then 50% good copper colouring results can be obtained and below 50% FF the colours obtained are no longer copper like but red/brownish.

1. A process for providing an aluminium article with a copper coating, comprising:
(a) anodizing said aluminium article to produce an anodic oxide layer on the surface thereof; and
(b) colouring the anodized aluminium surface in an electrolytic bath comprising a copper salt, by subjecting the aluminium surface to an asymmetrical voltage controlled alternating block current having a positive phase and a negative phase, such that a metallic copper coloured coating is formed on the aluminium surface.

2. The process of claim 1, wherein the process is used for providing aluminium cookware with a copper coating.

3. The process of claim 1, wherein the mean current density applied to the aluminium surface in the positive phase is between 0.00 and 0.05 A/dm².

4. The process of claim 1, wherein the mean current density applied in the negative phase is between 0.08 and 0.4 A/dm².

5. The process of claim 1, wherein the frequency of the used pulse is between 5 and 50 Hz.

6. The process of claim 5, wherein the frequency is between 10 and 40 Hz.

7. The process of claim 6, wherein the frequency is between 15 and 30 Hz.

8. The process of claim 7, wherein the frequency is 20 Hz.

9. The process of claim 1, wherein the relation between the positive phase and negative phase, calculated as % FF, is above 50%.

10. The process of claim 9, wherein the relation between the positive phase and negative phase, calculated as % FF, is above 60%

11. The process of claim 10, wherein the relation between the positive phase and negative phase, calculated as % FF, is between 80% and 100%.

12. The process of claim 11, wherein the relation between the positive phase and negative phase, calculated as % FF, is 80%.

13. The process of claim 1, wherein the electrolytic bath comprises an acidic aqueous solution containing a copper salt selected from the group consisting of copper sulfate, copper acetate and copper phosphate.

14. The process of claim 13, wherein the copper salt is present in a concentration of 1-100 g/L.

15. The process of claim 1, wherein the electrolysis bath comprises sulphuric acid in a concentration of 0.5-25 g/L.

16. The process of claim 1, wherein the electrolysis bath further comprises magnesium sulphate or aluminium sulphate in a concentration of 0-50 g/L.

17. An aluminium article having a copper coating, obtainable by the process of claim 1.

18. The aluminium article of claim 17, wherein the article comprises aluminium cookware having a copper look.

19. The process of claim 14, wherein the copper salt is present in a concentration of 5-75 g/L.

20. The process of claim 14, wherein the copper salt is present in a concentration of 10-50 g/L.

21. The process of claim 14, wherein the copper salt is present in a concentration of 15-25 g/L.

22. The process of claim 14, wherein the copper salt is present in a concentration of 20 g/L.

23. The process of claim 15, wherein the electrolysis bath comprises sulphuric acid in a concentration of 1-20 g/L.

24. The process of claim 15, wherein the electrolysis bath comprises sulphuric acid in a concentration of 2-10 g/L.

25. The process of claim 15, wherein the electrolysis bath comprises sulphuric acid in a concentration of 3-7 g/L.

26. The process of claim 15, wherein the electrolysis bath comprises sulphuric acid in a concentration of 5 g/L.

27. The process of claim 16, wherein the electrolysis bath further comprises magnesium sulphate or aluminium sulphate in a concentration of 20 g/L.
